(19) United States
(12) Patent Application Publication
(10) Pub. No.: US 2013/0051534 A1
(43) Pub. Date: Feb. 28, 2013

(54) X-RAY WAVEGUIDE AND X-RAY WAVEGUIDE SYSTEM

(71) Applicants: Kohei Okamoto, Yokohama-shi (JP); Wataru Kubo, Inagi-shi (JP); Hirokatsu Miyata, Hadano-shi (JP)

(72) Inventors: Kohei Okamoto, Yokohama-shi (JP); Wataru Kubo, Inagi-shi (JP); Hirokatsu Miyata, Hadano-shi (JP)

(73) Assignee: CANON KABUSHIKI KAISHA, Tokyo (JP)

(21) Appl. No.: 13/591,616

(22) Filed: Aug. 22, 2012

(30) Foreign Application Priority Data
Aug. 30, 2011 (JP) 2011-187166
Dec. 2, 2011 (JP) 2011-265072

(51) Int. Cl. G21K 1/00

(52) U.S. Cl. 378/145

(57) ABSTRACT

An X-ray waveguide for propagation of an X-ray therethrough includes a core and a cladding. The core has a periodic structure in which plural substances having different refractive-index real parts are periodically arrayed in a direction perpendicular to an X-ray guiding direction. Given that a maximum length of the core in the X-ray guiding direction is l, a maximum thickness of the core is t, and a Bragg angle of the periodic structure for the X-ray is θ_{B}(°), at least one end surface of a core region in the X-ray guiding direction is inclined at an inclination angle φ(°), which satisfies tan⁻¹(t/l)<φ<90°−θ_{B}, with respect to an interface between the core and the cladding in a plane containing a direction that is parallel to the X-ray guiding direction and a direction that is perpendicular to the interface between the core and the cladding.

### BACKGROUND OF THE INVENTION

1. Field of the Invention

The present disclosure relates to an X-ray waveguide and an X-ray waveguide system; these may be useful in X-ray optical systems for X-ray imaging techniques.

2. Description of the Related Art

When imaging with electromagnetic radiation having short wavelengths of several tens of nanometers or less, large-sized spatial optical systems are primarily employed. The reason for this is that, because a difference in refractive index for the electromagnetic waves between different substances is very small, a total reflection angle and a refraction angle at the interface between the different substances are very small. One of main components of the spatial optical system is a multilayer reflecting mirror in which materials having different refractive indices are alternately laminated. The multilayer reflecting mirror serves for various roles, such as beam shaping, spot size conversion, and wavelength selection.

In contrast to the primarily-used spatial optical system mentioned above, a related-art X-ray waveguide, e.g., a polycapillary fiber, serves to propagate (transmit) an X-ray in such a state that the X-ray is enclosed in a waveguide portion made of a homogeneous medium, e.g., air. Recently, X-ray waveguides for propagating electromagnetic waves in a state enclosed in a thin film or a multilayer film have been studied with intent to reduce the size and to improve the performance of an optical system. As one example, a thin film waveguide in which a waveguide core made of a homogeneous substance sandwiched between two cladding (clad) layers in one-dimensional direction has been proposed. See “Analysis of tapered front-coupling X-ray waveguides”, by I. Bukreeva, et al., Journal of Synchrotron Radiation, Vol. 17, p. 61 (2010), (Non-Patent Document 1). As another example, an X-ray waveguide in which an incident-side end surface of a waveguide core is formed perpendicularly to a wave-guiding direction for an X-ray (called an “X-ray guiding direction”) has been proposed. See, “X-ray waveguide nanostructures: Design, fabrication, and characterization”, by A. Jarre et al., Journal of Applied Physics, Volume 101, p. 054306 (2007). (Non-Patent Document 2). The proposed thin film waveguide is intended to make the X-ray directly incident upon the waveguide core parallel to the X-ray guiding direction, thereby creating a low-order waveguide mode for propagation of the X-ray through the waveguide.

Non-Patent Document 1 discloses the X-ray waveguide in which the X-ray is enclosed in the core made of a homogeneous medium, e.g., air, to create a low-order waveguide mode such that the X-ray is propagated through the waveguide. In the X-ray waveguide disclosed in Non-Patent Document 1, the core is to be very thin and the width of an incident-side end surface of the core is to be very small in order to create only the low-order X-ray waveguide mode. Accordingly, the X-ray waveguide disclosed in Non-Patent Document 1 has the problems that a propagation loss due to seeping (leakage) of the X-ray to the cladding is large, and that the amount of X-ray capable of being propagated through the waveguide is small.

Non-Patent Document 2 discloses the X-ray waveguide in which the core is made of a homogeneous medium and the end surface of the core is perpendicular to the X-ray guiding direction. In the X-ray waveguide disclosed in Non-Patent Document 2, an area of the core is small and a cross-sectional area of the X-ray entering the end surface of the waveguide core on the X-ray incident side is also small in order to create the low-order waveguide mode. Accordingly, the X-ray waveguide disclosed in Non-Patent Document 2 has the problems that coupling efficiency of the X-ray is low because the refractive index is greatly changed at the X-ray incident side of the core, and that the amount of X-ray capable of being propagated through the waveguide is small because a cross-sectional area of the waveguide is small.

### SUMMARY OF THE INVENTION

The present disclosure provides an X-ray waveguide and an X-ray waveguide system, which enable an incident X-ray to be coupled to a waveguide with high efficiency.

According to one aspect of the present disclosure, there is provided an X-ray waveguide for guiding an X-ray to be propagated therethrough. The X-ray waveguide includes a core and a cladding. The core has a periodic structure in which plural substances having different refractive-index real parts are periodically arrayed in a direction perpendicular to an X-ray guiding direction. Given that a maximum length of the core in the X-ray guiding direction is l, a maximum thickness of the core is t, and a Bragg angle of the periodic structure of the core for the X-ray is θ_{B}(°), at least one end surface of a core region in the X-ray guiding direction is inclined at an inclination angle φ(°), which satisfies a following formula (1), with respect to an interface between the core and the cladding in a plane containing a direction that is parallel to the X-ray guiding direction and a direction that is perpendicular to the interface between the core and the cladding:

tan⁻¹(t/l)<φ<90°−θ_{B} (1).

According to another aspect of the present disclosure, there is provided an X-ray waveguide system including an X-ray source and an X-ray waveguide, the X-ray source emitting an X-ray to enter an end of the X-ray waveguide, the X-ray waveguide including a core and a cladding, wherein the core has a periodic structure in which plural substances having different refractive-index real parts are periodically arrayed in a direction perpendicular to an X-ray guiding direction, and wherein, given that a maximum length of the core in the X-ray guiding direction is l, a maximum thickness of the core is t, and a Bragg angle of the periodic structure of the core for the X-ray emitted from the X-ray source is θ_{B}(°), at least one end surface of the core in the X-ray guiding direction is inclined at an inclination angle φ(°), which satisfies a following formula (1), with respect to an interface between the core and the cladding in a plane containing a direction that is parallel to the X-ray guiding direction and a direction that is perpendicular to the interface between the core and the cladding:

tan⁻¹(t/l)<φ<90°−θ_{B} (1).

Further features of the present invention will become apparent from the following description of exemplary embodiments with reference to the attached drawings.

### BRIEF DESCRIPTION OF THE DRAWINGS

FIG. 1 is a schematic view illustrating an example of an X-ray waveguide according to the present disclosure.

FIGS. 2A and 2B are explanatory views illustrating different examples of the X-ray waveguide.

FIG. 3 is a schematic view illustrating an example of a waveguide region of the X-ray waveguide.

FIG. 4 is an explanatory view of a wavenumber vector and an effective propagation angle.

FIG. 5 is a graph representing the relationship between a loss of a waveguide mode and an effective propagation angle in the waveguide region of the X-ray waveguide.

FIG. 6A is a schematic view illustrating a part of the waveguide region in an example of the X-ray waveguide, and FIG. 6B illustrates an electric-field intensity distribution within a core in a periodic resonance waveguide mode that is created in the waveguide region in the example of the X-ray waveguide.

FIG. 7 is a schematic view illustrating an example of the X-ray waveguide, which is capable of creating the periodic resonance waveguide mode.

FIG. 8 is a schematic view illustrating an X-ray waveguide of EXAMPLE 1.

FIG. 9 is a graph representing an electric-field intensity distribution within a core in a waveguide mode, which is created in the X-ray waveguide of EXAMPLE 1, with respect to an effective propagation angle and a position within the core.

FIG. 10 is a schematic view illustrating an X-ray waveguide used in EXAMPLES 2 to 5.

FIG. 11 is a graph representing the relationship between a loss and an effective propagation angle of a waveguide mode that is created in the X-ray waveguide of EXAMPLE 2.

FIG. 12 illustrates a distribution of real part of an electric field within a core in a periodic resonance waveguide mode, which is created in the X-ray waveguide of EXAMPLE 2.

FIG. 13 is a graph representing the relationship between a loss of a waveguide mode, which is created in the X-ray waveguide of EXAMPLE 4, and an effective propagation angle.

FIG. 14 is a sectional view, taken in a wave-guiding direction, of the X-ray waveguide of EXAMPLE 5.

FIG. 15 is a schematic view illustrating an example of an X-ray waveguide system according to the present disclosure.

### DESCRIPTION OF THE EMBODIMENTS

The present disclosure will be described in detail below.

An X-ray waveguide according to the present disclosure is a waveguide including a cladding and a core and guiding an X-ray with wavelengths of 1 pm (1×10⁻¹² m) or longer and 100 nm (1×10⁻⁷ m) or shorter to be propagated therethrough. The core has a periodic structure in which plural substances having different refractive-index real parts are periodically arrayed in a direction perpendicular to an X-ray guiding direction. Given that a maximum length of the core in the X-ray guiding direction is l, a maximum thickness of the core is t, and a Bragg angle of the periodic structure of the core for the X-ray is θ_{B} degrees (°), at least one end surface of a core region in the X-ray guiding direction is inclined at an inclination angle φ(°), which satisfies the following formula (1), with respect to an interface between the core and the cladding in a plane containing a direction that is parallel to the X-ray guiding direction and a direction that is perpendicular to the interface between the core and the cladding:

tan⁻¹(t/l)<φ<90°−θ_{B} (1).

In the present disclosure, the term “X-ray” implies X-ray radiation, and includes an electromagnetic wave in a frequency band or a wavelength band where a refractive-index real part of a substance is 1 or less. More specifically, in the present disclosure, the term “X-ray” implies an electromagnetic wave in a general X-ray band where a wavelength is 1 pm or longer and 100 nm or shorter, including Extreme Ultra Violet (EUV) light. The X-ray waveguide according to the present disclosure is to guide the electromagnetic wave corresponding to the above-mentioned X-ray. Furthermore, a frequency of the electromagnetic wave having such a short wavelength is very high and a peripheral electron of a substance is not responsive to that electromagnetic wave. It is hence known that a real part of refractive index of a substance is smaller than 1 for the X-ray unlike for electromagnetic waves (visible light and infrared light) in a frequency band where wavelengths are not shorter than that of ultraviolet light. A refractive index n of a substance for the above-mentioned X-ray is generally expressed by the following formula (2):

n=1−δ−i\tilde{β}=ñ−i\tilde{β} (2).

Thus, the refractive index n is expressed by a deviation δ from 1 in the real part and an imaginary part

\tilde{β}

related to absorption.

Because δ is proportional to an electron density ρₑ of a substance, a real part of refractive index of the substance becomes smaller as the substance has a larger electron density. The refractive-index real part is expressed by:

ñ=1−δ

Moreover, the electron density ρₑ is proportional to an atomic density ρₐ and an atomic number Z. Thus, the refractive index of a substance for the X-ray is expressed by using a complex number. In this specification, a real part of the complex number is called a “refractive-index real part” or a “real part of refractive-index”, and an imaginary part of the complex number is called a “refractive-index imaginary part” or an “imaginary part of refractive-index”.

The refractive-index real part is maximized for the X-ray when the X-ray propagates in vacuum. In typical environments, however, the refractive-index real part is maximized in air in comparison with those of almost all substances other than gases. The term “substance” used in this specification involves air and vacuum. Even when mesostructures and mesostructured materials in the form of mesoporous materials, for example, are individually made of a single material, they include portions made of air or vacuum and having different refractive indices from that of the single material. Accordingly, they are each regarded as being composed of plural substances.

With the X-ray waveguide according to the present disclosure, the X-ray is enclosed in the core with total reflection of the X-ray at the interface between the core and the cladding to create a waveguide mode, whereby the X-ray is propagated through the waveguide. A direction in which the X-ray in the waveguide mode created at that time is guided for propagation is called an “X-ray guiding direction” in this specification. The X-ray guiding direction is the same direction as that of the propagation constant of the waveguide mode, the propagation constant being derived on the basis of the waveguide theory. The term “plural substances having different refractive-index real parts” in the present disclosure imply two or more substances that differ in electron density from each other in many cases. A minimum unit structure in a periodic structure is called a “unit structure” in this specification. A periodic structure of the core has one-, two- or three-dimensional periodicity in a plane perpendicular to the X-ray guiding direction, i.e., to the interface between the core and the cladding.

The X-ray waveguide according to the present disclosure guides the X-ray to be propagated therethrough by enclosing the X-ray within the core with total reflection at the interface between the core and the cladding. The X-ray guiding direction is defined as a z-direction by using the orthogonal coordinate system. In the X-ray waveguide according to the present disclosure, a refractive-index real part of the core is larger than that of the cladding near the interface between the core and the cladding, and the X-ray entering the interface between the core and the cladding at an angle smaller than a total-reflection critical angle is totally reflected at the interface and is enclosed within the core. The total-reflection critical angle is defined as an angle in a plane that is parallel to the X-ray guiding direction and that is perpendicular to the interface between the core and the cladding, and it is denoted by θ_{C}(°).

Given that a refractive-index real part of a substance on the cladding side at the interface between the core and the cladding is n_{clad} and a refractive-index real part of a substance on the core side at the interface is n_{core}, the total-reflection critical angle θ_{C}(°) with respect to the direction parallel to the interface between the core and the cladding is expressed by the following formula (3) on condition of n_{clad}<n_{core}:

$${θ}_{c} = \frac{180}{π} arccos ( \frac{{n}_{clad}}{{n}_{core}} ) . \qquad ( 3 )$$

It is, however, to be noted that because the core of X-ray waveguide according to the present disclosure has a periodic structure and a period, i.e., a unit structure, of the periodic structure is very small, n_{core} in the formula (3) is not equal to the exact refractive-index real part of the substance on the core side at the interface between the core and the cladding. Thus, n_{core} is thought as being a value close to both the exact refractive-index real part and an average refractive-index real part over the entire periodic structure.

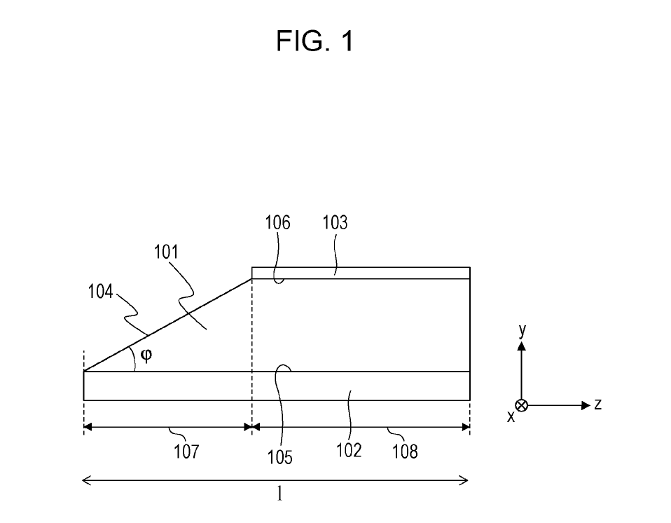

The present disclosure will be described below with reference to the drawings. FIG. 1 is a schematic view illustrating an example of the X-ray waveguide according to the present disclosure. In FIG. 1, the X-ray waveguide includes a core 101 through which the X-ray is guided for propagation, and claddings 102 and 103 surrounding the core 101. The core 101 is contacted with the cladding 102 at an interface 105 and is contacted with the cladding 103 at an interface 106. In FIG. 1, the X-ray guiding direction is defined as the direction of a z-axis. In the core 101 of the X-ray waveguide according to the present disclosure, at least one end surface 104 in the X-ray guiding direction (z-direction) is inclined at an inclination angle φ(°), which satisfies the above-mentioned formula (1), with respect to the interface 105 (or 106) between the core 101 and the cladding 102 (or 103) in a plane (y-z plane in FIG. 1) that is parallel to the X-ray guiding direction and that is perpendicular to the interface 105 (or 106) between the core and the cladding. In the formula (1), l is the maximum length of the core in the X-ray guiding direction, and t is the maximum thickness of the core. Further, θ_{B} is the Bragg angle of the periodic structure of the core for the X-ray in the plane (y-z plane in FIG. 1) that is parallel to the X-ray guiding direction and that is perpendicular to the interface 105 (or 106) between the core 101 and the cladding 102 (or 103).

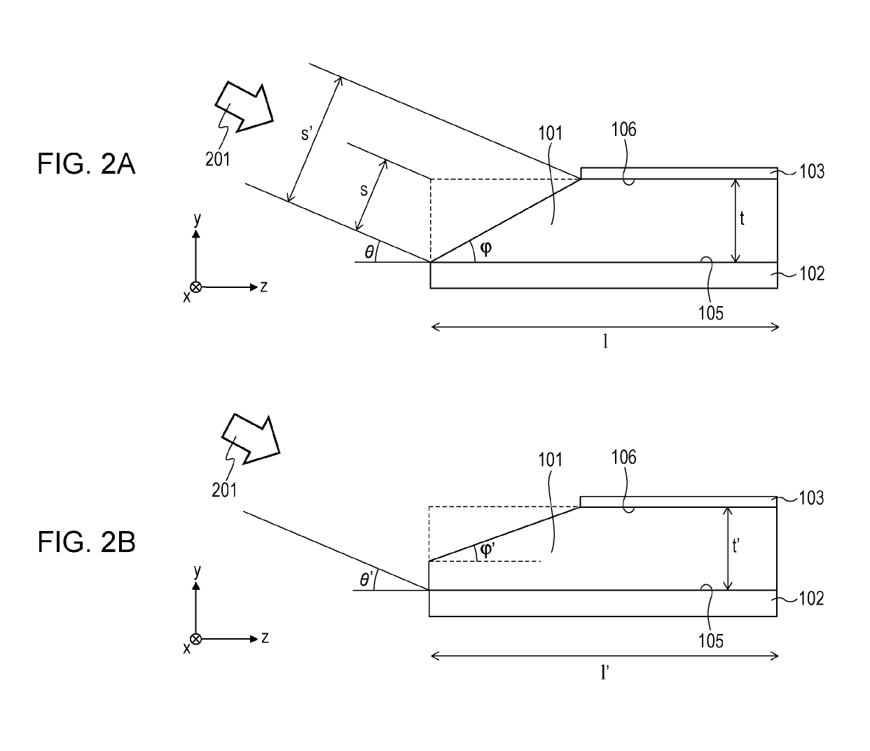

Since the end surface of the core is inclined as described above, a larger amount of X-ray is made incident upon a core region. In the X-ray waveguide according to the present disclosure, as illustrated in FIG. 1, a zone in the z-direction including a portion where the end surface of the core is inclined is called a “coupling region 107”, and a zone in the z-direction where the inclined end surface of the core is not present is called a “waveguide region 108”. FIG. 2A illustrates an example in which the X-ray is incident upon the X-ray waveguide at an angle θ with respect to the interface 105 between the core 101 and the cladding 102, as indicated by an arrow 201. Dotted lines in FIG. 2A represent the configuration of the cladding and the end surface in the case where the end surface of the core 101 is not inclined, i.e., the case of φ=90°. In that case, a size of a region including a part of the incident X-ray, which part directly enters the core, is denoted by s. The size s is a length of a portion of an intersection line between a distribution of the incident X-ray (light) in a cross-section perpendicular to the propagation direction of the incident X-ray and a y-z plane near the end surface of the waveguide, the incident X-ray in that portion of the intersection line entering the end surface of the waveguide. In contrast, a size s′ of a region of the X-ray entering the core end surface, which is inclined at the angle φ satisfying the formula (1), is larger than s as expressed by the following formula (4). Thus, efficiency of coupling of the X-ray to the waveguide is increased. Moreover, since the core end surface is inclined, scattering of the X-ray in an incident portion of the waveguide is also reduced and the coupling efficiency is further increased.

$${s}^{′} = \frac{sin ( ϕ + θ )}{cos θ sin ϕ} s \qquad ( 4 )$$

A method of forming the core end surface inclined so as to satisfy the formula (1), i.e., a method of forming the coupling region, is practiced, for example, by using a cross-section polisher that performs polishing with bombardment of an argon ion beam. When such a method is employed, the polishing is performed in a state where the X-ray waveguide constituted by the core sandwiched between the claddings and including only the waveguide region is set such that the X-ray guiding direction in the waveguide is inclined at the angle φ(°) with respect to the bombarding direction of the argon ion beam. As a result of the polishing, the core end surface inclined at the angle φ(°) is formed as illustrated in FIG. 1. Another example of the method of forming the core end surface is as follows. A shield mask is formed on the surface of the X-ray waveguide, which is constituted by the core sandwiched between the claddings and which does not include the inclined core end surface, i.e., the coupling region, near a position where the waveguide region is to be formed. Then, etching is performed with the X-ray waveguide inclined such that the surface of the X-ray waveguide in inclined at the angle φ with respect to an incoming direction of an etching gas.

In the X-ray waveguide according to the present disclosure, as illustrated in FIG. 2B, the core end surface upon which the X-ray is incident may be partly inclined.

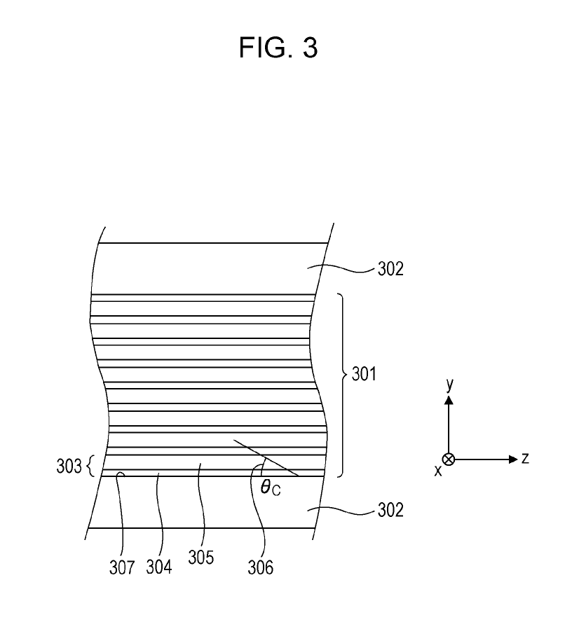

In the X-ray waveguide according to the present disclosure, a prominent X-ray waveguide mode created in the core with the total reflection at the interface between the core and the cladding is a periodic resonance waveguide mode that is greatly affected by periodicity. The term “periodic resonance waveguide mode” in this specification implies a waveguide mode in which the X-ray strongly resonates with a periodic structure as a result of multiple diffraction of the X-ray due to the periodic structure. Thus, the periodic resonance waveguide mode is a mode resonating with the periodic structure, and it is related to a one-dimensional Bragg diffraction when the periodic structure is one-dimensional, to two-dimensional Bragg diffractions at maximum when the periodic structure is two-dimensional, and to tree-dimensional Bragg diffractions at maximum when the periodic structure is three-dimensional. In the X-ray waveguide according to the present disclosure, the periodic resonance waveguide mode is formed by enclosing the waveguide mode, which is attributable to the Bragg diffraction and which resonates with the periodic structure, in the core with the total reflection at the interface between the core and the cladding. FIG. 3 illustrates an X-ray waveguide according to the present disclosure in which a core has a one-dimensional periodic structure. The X-ray guiding direction is the z-direction in FIG. 3. A core 301 has a one-dimensional periodic structure in which a plurality of unit structures 303, each including a low refractive-index real part layer 304 made of a substance having a small refractive-index real part and a high refractive-index real part layer 305 made of a substance having a large refractive-index real part, are periodically laminated in the y-direction at a period d. Claddings 302 are disposed in contact with, and are arranged in sandwiching relation to, the core 301 in the y-direction. Therefore, an influence of periodicity is maximized in the y-direction. Reference numeral 306 denotes the total-reflection critical angle θ_{C} that is measured at an interface 307 between the core 301 and the cladding 302 with respect to the interface 307. The X-ray present in the core 301 and incident upon the interface 307 at an angle smaller than the total-reflection critical angle θ_{C} is totally reflected and enclosed in the core 301 in the y-direction. The X-ray thus enclosed creates waveguide modes in a direction parallel to the y-z plane, and respective fundamental waves of the waveguide modes have different effective propagation angles below:

\tilde{θ}(°)

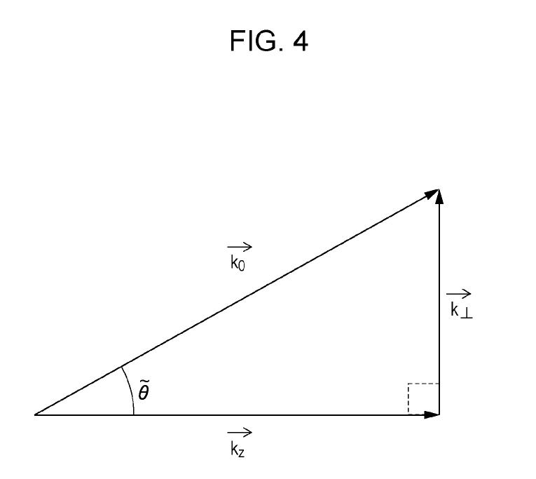

The term “fundamental wave” implies one plane wave on the basis of an approximation that the waveguide mode is created by interference when the one plane wave is propagated while repeating the total reflection at the interface between the core and the cladding. As illustrated in FIG. 4, given that a z-component of a wavenumber vector of each waveguide mode in the core, i.e., a propagation constant, is k_{z} and a wavenumber vector in vacuum is k₀, an effective propagation angle

\tilde{θ}

is defined as:

$$\tilde{θ} = \frac{180}{π} arccos ( \frac{{k}_{z}}{{k}_{0}} )$$

Thus, it is thought that the effective propagation angle

\tilde{θ}(°)

is basically an angle formed between the fundamental wave of the waveguide mode and the X-ray guiding direction. It is also thought that the fundamental wave of each of the created waveguide modes is reflected substantially at the effective propagation angle

\tilde{θ}

by the interface 307 between the core and the cladding. In order to create the waveguide mode in the X-ray waveguide, the effective propagation angle

\tilde{θ}

of the waveguide mode is to be smaller than θ_{C}.

In this specification, when an electromagnetic wave creating the waveguide mode is generalized and considered as one plane wave, the fundamental wave is an electromagnetic wave that is presumed to be propagated at the effective propagation angle

\tilde{θ}

with respect to the X-ray guiding direction (z-direction). Further, as illustrated in FIG. 4, a wavenumber vector of the fundamental wave in a direction perpendicular to the X-ray guiding direction (z-direction) is called a perpendicular component k_{⊥} of the wavenumber vector. Because the effective propagation angle of the periodic resonance waveguide mode is close to the Bragg angle θ_{B} of the periodic structure for the X-ray, the periodic resonance waveguide mode is created by constructing the X-ray waveguide so as to satisfy the following formula (5):

θ_{B}<θ_{C} (5).

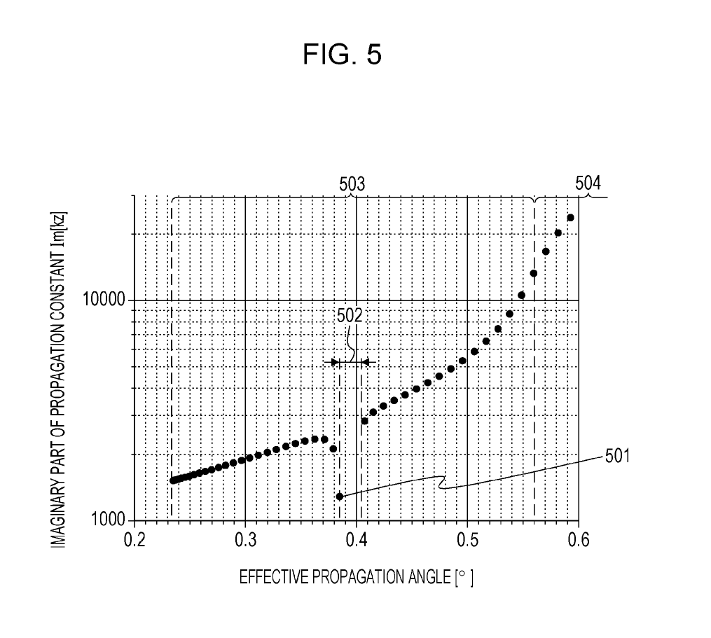

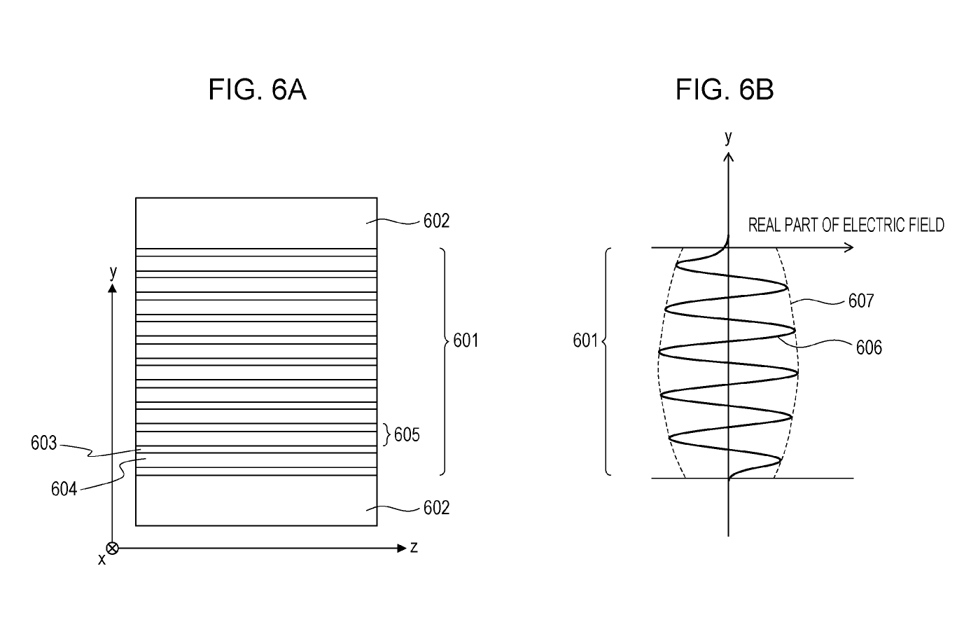

FIG. 5 is a graph plotting a loss of the waveguide mode created in the X-ray waveguide, in which the core has the one-dimensional periodic structure illustrated in FIG. 3 and a periodic number of the periodic structure is 25, with respect to the effective propagation angle of the waveguide mode. Because the loss of the waveguide mode is proportional to an imaginary part Im [kz] of the propagation constant, the vertical axis of FIG. 5 represents Im [kz]. Reference numeral 502 corresponds to an angle band of the Bragg reflection, 503 corresponds to an effective propagation angle band of the waveguide mode, and 504 corresponds to an angle band of a radiation mode in which the effective propagation angle exceeds the total-reflection critical angle at the interface between the core and the cladding. The Bragg angle generally indicates a center angle in the angle band of the Bragg reflection. In this specification, however, the Bragg angle indicates a minimum angle in the angle band of the Bragg reflection. This implies that the Bragg angle corresponds to the effective propagation angle in the periodic resonance waveguide mode in this specification. The loss 501 of the periodic resonance waveguide mode is very small in comparison with losses of other waveguide modes having their effective propagation angles around the effective propagation angle in the periodic resonance waveguide mode. In the X-ray waveguide constructed to satisfy the formula (5), therefore, the periodic resonance waveguide mode becomes a prominent waveguide mode such that the X-ray is propagated with a very small loss. Hitherto, when a core is a homogeneous medium, a core region has been made very small in order to obtain the waveguide mode as a single mode. In contrast, with the X-ray waveguide according to the present disclosure, because of utilizing the periodic structure, the core region is increased and the periodic resonance waveguide mode having a lower loss is created as a single waveguide mode in a particular direction. In this specification, the expression “single wavelength mode” implies that one waveguide mode is most easily selected in comparison with other waveguide modes and it becomes prominent among the plural waveguide modes. An X-ray waveguide illustrated in FIG. 6A includes a core 601 in which a plurality of unit structures 605, each including a substance 604 having a large refractive-index real-part (or a substance 604 having a small refractive-index imaginary part) and a substance 603 having a small refractive-index real-part (or a substance 603 having a large refractive-index imaginary part), are one-dimensionally periodically laminated. Claddings 602 are arranged in sandwiching relation to the core 601, and the X-ray waveguide is constructed so as to satisfy the formula (5). For the sake of simplicity, FIG. 6A illustrates the case where the periodic number is small. In a graph of FIG. 6B, a solid line 606 represents a distribution of a real part of an electric field in the periodic resonance waveguide mode that is created in the X-ray waveguide illustrated in FIG. 6A. The y-axis in FIG. 6B is illustrated corresponding to that in FIG. 6A. As seen from FIGS. 6A and 6B, the electric field in the periodic resonance waveguide mode is concentrated in the substance 604 having the large refractive-index real-part, i.e., in the substance 604 having a small absorption loss, inside the core 601. Further, an envelop function of the electric field distribution in the periodic resonance waveguide mode, which is represented by dotted lines 607 in FIG. 6B, has a shape indicating that the electric field is relatively increased near a center of the core 601. In the periodic resonance waveguide mode, seeping of the X-ray to the cladding is reduced and the propagation loss is further reduced. Moreover, the seeping of the X-ray to the cladding is further reduced by increasing the periodic number. As a result, the propagation loss of the periodic resonance waveguide mode is very small. When the structure of the waveguide is more symmetric in the direction perpendicular to the X-ray guiding direction, an envelop curve in the periodic resonance waveguide mode has a shape indicating that the electric field is relatively increased near the center of the core, as illustrated in FIG. 6B. Moreover, a position where the electric field is increased may be changed within the core by modifying the structure of the waveguide from the symmetric one.

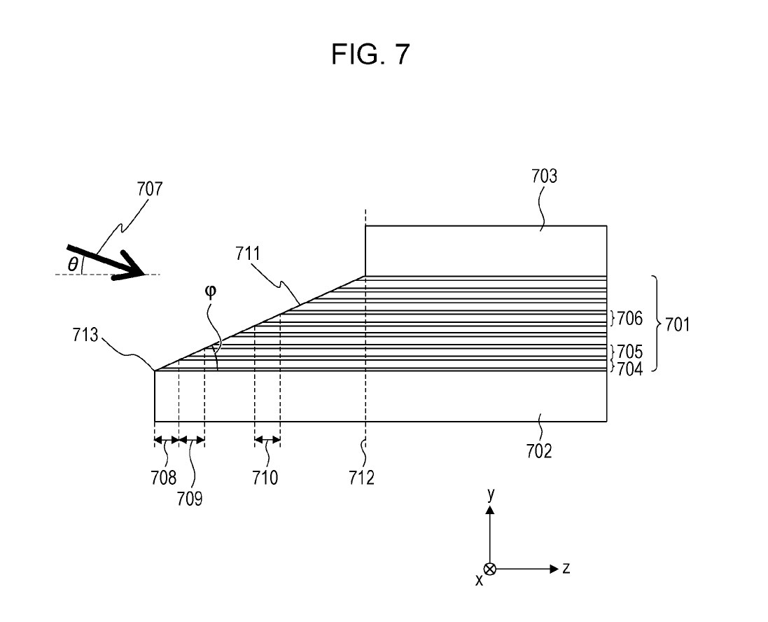

FIG. 7 illustrates an X-ray incident portion and thereabout of an X-ray waveguide, which satisfies the formula (5). In FIG. 7, a direction toward the backside of the drawing sheet from the front side is defined as an x-axis (x-) direction, a direction toward the upper side of the drawing sheet from the lower side is defined as a y-axis (y-) direction, and a direction toward the right side of the drawing sheet from the left side, i.e., an X-ray guiding direction, is defined as a z-axis (z-) direction. In FIG. 7, a position denoted by 713 is defined as x=y=z=0. The X-ray waveguide has a structure that a core 701 is sandwiched between a lower cladding 702 and an upper cladding 703. An end surface 711 of the core 701 on the X-ray incident side is inclined at an angle φ(°) with respect to an interface between the lower cladding 702 and the core 701 (i.e., to a z-x plane). An X-ray 707 capable of being regarded as substantially a plane wave is incident upon the waveguide from the left side on the drawing sheet. The incident X-ray 707 enters the waveguide at an angle θ(°) with respect to the z-direction in FIG. 7. The core 701 is constructed by laminating a plurality of unit structures. A unit structure closest to y=0 in FIG. 7 is denoted by 704, and a unit structure second closest to y=0 is denoted by 705. Given that an arbitrary natural number of 3 or more is k, a unit structure k-th closest to y=0 is denoted by 706. In a z-directional range corresponding to a zone 708, the X-ray enters only the unit structure 704. In a z-directional range corresponding to a zone 709, the X-ray directly enters only the unit structure 705. In a z-directional range corresponding to a zone 710, the X-ray directly enters only the unit structure 706. In the z-directional range corresponding to the zone 709, however, the X-ray having directly entered the unit structure 705 causes diffraction and interference with the X-ray having directly entered the unit structure 704 and having transmitted therethrough. In a z-directional range corresponding to a larger k, the X-rays having directly entered plural unit structure cause multiple diffractions and multiple interferences. When the core end surface is inclined as in the X-ray waveguide according to the present disclosure, the incident X-ray is gradually converted to a propagated X-ray having an electromagnetic field distribution, which is close to the electromagnetic field of the waveguide mode, while sequentially causing multiple interferences in the positive z- and y-directions from a part of the core region closest to y=0. Therefore, scattering, etc. of the X-ray upon the incidence thereof is suppressed, and a coupling loss is reduced. The gradually converted X-ray is smoothly coupled to the waveguide mode near a position 712 from which the upper cladding 703 is present in the positive z-direction. Thus, the X-ray waveguide according to the present disclosure is an X-ray waveguide having high coupling efficiency. In particular, when the incident angle θ(°) is equal to the Bragg angle of the periodic structure of the core, the X-ray is coupled to the periodic resonance waveguide mode with high coupling efficiency.

Further, the X-ray waveguide according to the present disclosure is to be constructed such that the inclination angle φ of the core end surface on the incident side in the X-ray guiding direction is equal to the Bragg angle θ_{B} (substantially the effective propagation angle of the periodic resonance waveguide mode) of the periodic structure of the waveguide core for the X-ray. As described above, in this specification, the Bragg angle is equivalent to the effective propagation angle of the periodic resonance waveguide mode. However, the expression “φ is equal to θ_{B}” is not limited to the case that they are exactly equal to each other, and it implies that the Bragg angle is equal to the effective propagation angle of the periodic resonance waveguide mode in the core, which angle is determined in consideration of refraction, etc. occurred inside the waveguide. As seen from the electric field distribution illustrated in FIG. 6B, the electric field of the periodic resonance waveguide mode in the periodic structure of the core has such a distribution that the electric field oscillates at the same period as that of the periodic structure in the y-direction, and a phase of the electric field also oscillates between +π and −π at the same period.

In order to efficiently couple the X-ray to the periodic resonance waveguide mode having the above-described characteristic, it is important to form the X-ray resonating with the periodic structure in the incident portion of the waveguide core, i.e., in the coupling region thereof. This is equivalent to forming the electric field, which provides an X-ray phase difference π between the adjacent unit structures, in the core end surface of the X-ray waveguide according to the present disclosure, the core end surface being inclined so as to satisfy the formula (5). Thus, the highly-efficient coupling of the X-ray to the periodic resonance waveguide mode is obtained by making the X-ray incident, at an angle equal to the Bragg angle in the core (i.e., the effective propagation angle of the periodic resonance waveguide mode in the core) with respect to the X-ray guiding direction, upon the core end surface of the X-ray waveguide, which is constructed such that the inclination angle φ of the core end surface on the incident side in the X-ray guiding direction is equal to the Bragg angle θ_{B} of the periodic structure of the waveguide core for the X-ray (i.e. to the effective propagation angle of the periodic resonance waveguide mode in the core). Here, the incident angle is derived from the Bragg angle in the core, taking into account refraction at the incident end surface of the core.

Moreover, in the X-ray waveguide according to the present disclosure, a cladding may be formed on the surface of the coupling region of the core, in which the core end surface on the X-ray incident side is inclined. The cladding thus formed inhibits the X-ray, which has entered the coupling region including the inclined core end surface, from being radiated to the outside of the waveguide from the inclined core end surface. The X-ray having entered the core region including the inclined core end surface is totally reflected at an interface between a cladding material and the core to be propagated through the waveguide core again. Accordingly, the propagation loss is reduced. Given that a total-reflection critical angle at an interface between the above-mentioned cladding and a substance present outside the waveguide in contact with the cladding is θ_{C-ext}(°), the X-ray waveguide is to be constructed so as to satisfy the following formula (6) in relation to the inclination angle φ(°) and the Bragg θ_{B}(°):

φ>θ_{C-ext}−θ_{B} (6).

By satisfying the above condition, the angle formed between the propagating direction of the incident X-ray and the inclined core end surface becomes larger than the total-reflection critical angle at the surface of the cladding material that is disposed on the inclined core end surface, and a loss due to the total reflection at the surface of the cladding material disposed on the inclined core end surface is not caused upon the incidence of the X-ray. Moreover, absorption and partial reflection upon the incidence of the X-ray are suppressed by setting a thickness of the cladding material disposed on the inclined core end surface to be 10 nm or less.

The periodic structure of the core may be any of periodic structures having one-, two-, and three-dimensional periodicity. However, the periodic structure of the core is at least to have periodicity in a plane perpendicular to the X-ray guiding direction and periodicity in a direction parallel to a segment connecting the two claddings, which sandwich the core therebetween, through the shortest distance.

Examples of the one-dimensional periodic structure of the core includes a one-dimensional periodic multilayer film in which a material having a large refractive-index real part and a material having a small refractive-index real part are alternately laminated, and a periodic structure having at least one-dimensional periodicity. The periodic structure may be a two- or three-dimensional periodic structure that has a one-dimensional periodic structure in the direction parallel to the segment connecting the two claddings, which sandwich the core therebetween, through the shortest distance, while the one-dimensional periodic structure is changed in a particular direction.

For the multilayer film of the one-dimensional periodic structure, carbon (C), boron carbide (B₄C), boron nitride (BN), beryllium (Be), etc. may be optionally used as the material having a large refractive-index real part. Also, aluminum oxide (Al₂O₃), magnesium oxide (MgO), silicon carbide (SiC), silicon nitride (Si₃N₄), titanium oxide (TiO₂), etc. may be optionally used as the material having a small refractive-index real part. The one-dimensional periodic structure of the core may be not only a structure in which the material having a large refractive-index real part and the material having a small refractive-index real part are alternately laminated structure, but also a periodic mesostructured material that is formed by a self-organization process. The periodic mesostructured material having one-dimensional periodicity includes, for example, a lamellar structure in which SiO₂ and an organic substance are periodically arrayed in a direction perpendicular to the surface of a thin film, and a two-dimensional mesoporous material having periodicity in a direction perpendicular to the material surface, but not having orientation in an in-plane direction.

The two-dimensional periodic structure includes, for example, a structure formed by periodically patterning a thin film, which is made of the material having a small refractive-index real part, in an in-plane direction by a semiconductor process, such as electron-beam lithography or etching, and then periodically laminating the patterned thin film, and a two-dimensional periodic mesostructured material having uniaxial orientation.

The three-dimensional periodic structure includes, for example, cavities having diameters of several nanometers to several tens nanometers, and a three-dimensional periodic mesostructured material. Another example of the three-dimensional periodic structure is the so-called artificial opal structure having the three-dimensional periodic structure in which polystyrene balls having diameters of about 50 nm are arrayed in a hexagonal close-packed structure by self-organization.

The period of the periodic structure forming the core of the X-ray waveguide according to the present disclosure is to be 9 nm or more and 50 nm or less. If the period of the periodic structure is less than 9 nm, the propagation loss is increased. If the period of the periodic structure is more than 50 nm, the periodic resonance waveguide mode is hard to generate.

The mesostructured material having the one-dimensional periodic structure and formed by the self-organization process will be described below. In this specification, the mesostructured material having the one-dimensional periodic structure is called a mesostructured film having the lamellar structure.

The mesostructured film according to the present disclosure is a periodic structure member having a structural period of 2 nm or more and 50 nm or less. The lamellar structure is a layered structure in which layers of two kinds of different substances are periodically arranged in a one-dimensional direction perpendicular to the layer surface. The two kinds of substances are made of a substance primarily containing an inorganic component and a substance primarily containing an organic component. The substance primarily containing an inorganic component and the substance primarily containing an organic component may be chemically bonded to each other in some cases. A practical example obtained with chemical bonding of the substance primarily containing an inorganic component and the substance primarily containing an organic component is a mesostructured material made of a siloxane compound to which an alkyl group is bonded.

### (Substance Primarily Containing Inorganic Component)

Materials of the substance primarily containing an inorganic component are not limited to particular ones. An inorganic oxide may be used from the viewpoint of forming the periodic structure member by substances having different refractive-index real parts. Examples of the inorganic oxide include silicon oxide, tin oxide, zirconia oxide, titanium oxide, niobium oxide, tantalum oxide, aluminum oxide, tungsten oxide, hafnium oxide, and zinc oxide. The surface of the inorganic oxide may be modified in some cases. For example, the surface of the inorganic oxide may be modified with a hydrophobic molecule to suppress adsorption of water.

### (Substance Primarily Containing Organic Component)

Materials of the substance primarily containing an organic component are not limited to particular ones. That substance may be made of, e.g., a surfactant, a material in which a portion having the function of forming a molecular aggregate forms a wall region, or a material in which such a portion is bonded to a precursor of a material forming a wall region. The surfactant may be ionic or nonionic. The ionic surfactant may be, e.g., halide salt of a trimethylalkyl ammonium ion. The chain length of an alkyl chain therein is to be 10 or more and 22 or less in terms of carbon number. The nonionic surfactant may be, e.g., a surfactant containing polyethylene glycol as a hydrophilic group. The surfactant containing polyethylene glycol as a hydrophilic group may be, e.g., polyethylene glycol alkyl ether or a block copolymer of polyethylene glycol-polypropylene glycol-polyethylene glycol. The chain length of an alkyl chain in the polyethylene glycol alkyl ether is to be 10 or more and 22 or less in terms of carbon number. The repetition number of polyethylene glycol is to be 2 or more and 50 or less. The structural period is varied by changing a hydrophobic group or a hydrophilic group. Generally, the structural period is increased by using a hydrophobic group or a hydrophilic group having a larger size. The substance primarily containing an organic component may contain, e.g., water, an organic solvent, or salt in some cases. Examples of the organic solvent include alcohol, ether, and hydrocarbons.

A method of fabricating the mesostructured film is not limited to particular one. For example, the mesostructured film is fabricated by adding a precursor of an inorganic oxide to a solution of an amphipathic substance (particularly a surfactant), which functions as an aggregate, by forming a film from the solution, and by progressing a reaction for producing the inorganic oxide. The film may be formed by, e.g., dip coating, spin coating, or hydrothermal synthesis. An additive for adjusting the structural period may be added along with the surfactant. The additive for adjusting the structural period may be, e.g., a hydrophobic substance. Examples of the hydrophobic substance include alkanes and an aromatic compound not containing a hydrophilic group. One practical example is octane.

The precursor of the inorganic oxide may be, e.g., an alkoxide or a chloride of silicon or a metal element. Practical examples of the inorganic oxide include an alkoxide or a chloride of Si, Sn, Zr, Ti, Nb, Ta, Al, W, Hf, and Zn. Examples of the alkoxide include methoxide, ethoxide, propoxide, and any of those oxides, which is partly replaced with an alkyl group.

The periodic mesostructured material having the two- or three-dimensional structural period will be described below. Porous materials are classified depending on pore diameters by IUPAC (International Union of Pure and Applied Chemistry). Porous materials having pore diameters of 2 to 50 nm are classified into mesoporous materials. Recently, the mesoporous materials have been vigorously studied. As a result, a structure having mesopores, which are uniform in diameter and are regularly arrayed, is obtained by using a surfactant aggregate as a mold.

The periodic mesostructured material having the two- or three-dimensional structural period, according to the present disclosure, is:

(A) a mesoporous film or

(B) a mesoporous film having pores filled with primarily an organic compound,

which has the two- or three-dimensional structural period. Those materials are described in detail below.

### (A) Mesoporous Film

The mesoporous film is a porous material having pore diameters of 2 to 50 nm (i.e., mesoscale diameters). A wall material of the mesoporous film is not limited to particular one. The wall material may be, e.g., an inorganic oxide. Examples of the inorganic oxide include silicon oxide, tin oxide, zirconia oxide, titanium oxide, niobium oxide, tantalum oxide, aluminum oxide, tungsten oxide, hafnium oxide, and zinc oxide. The wall surface of the mesoporous film may be chemically modified in some cases. For example, the wall surface of the mesoporous film may be modified with a hydrophobic molecule to suppress adsorption of water.

A method of fabricating the mesoporous film is not limited to particular one. For example, the mesoporous film may be fabricated as follows. A precursor of an inorganic oxide is added to a solution of an amphipathic substance, of which aggregate functions as a mold. After forming a film from the solution, a reaction for producing the inorganic oxide is progressed. A porous material is then obtained by removing mold molecules.

While the amphipathic substance is not limited to particular one, it is a surfactant in some embodiments. The surfactant may be ionic or nonionic. The ionic surfactant may be, e.g., halide salt of a trimethylalkyl ammonium ion. The chain length of an alkyl chain therein is to be 10 or more and 22 or less in terms of carbon number. The nonionic surfactant may be, e.g., a surfactant containing polyethylene glycol as a hydrophilic group. The surfactant containing polyethylene glycol as a hydrophilic group may be, e.g., polyethylene glycol alkyl ether or a block copolymer of polyethylene glycol-polypropylene glycol-polyethylene glycol. The chain length of an alkyl chain in the polyethylene glycol alkyl ether is to be 10 or more and 22 or less in terms of carbon number. The repetition number of polyethylene glycol is to be 2 or more and 50 or less. The structural period is varied by changing a hydrophobic group or a hydrophilic group. Generally, the pore diameter (structural period) is increased by using a hydrophobic group or a hydrophilic group having a larger size. An additive for adjusting the structural period may be added along with the surfactant. The additive for adjusting the structural period may be, e.g., a hydrophobic substance. Examples of the hydrophobic substance include alkanes and an aromatic compound not containing a hydrophilic group. One practical example is octane. The precursor of the inorganic oxide may be, e.g., an alkoxide or a chloride of silicon or a metal element. Practical examples of the inorganic oxide include an alkoxide or a chloride of Si, Sn, Zr, Ti, Nb, Ta, Al, W, Hf, and Zn. Examples of the alkoxide include methoxide, ethoxide, propoxide, and any of those oxides, which is partly replaced with an alkyl group.

The mesoporous film may be formed by, e.g., dip coating, spin coating, or hydrothermal synthesis.

The mold molecules may be removed by, e.g., firing, extraction, ultraviolet irradiation, or ozone treatment.

In the case of a structure in which plural pores are elongated in a uniaxial direction and those pores are two-dimensionally periodically arrayed in a plane perpendicular to the uniaxial direction, such a mesostructured film is a two-dimensional periodic mesostructured material having two-dimensional structural periods. Also, in the case of a structure in which pores are cavities having mesoscale diameters and those pored are three-dimensionally periodically arrayed, such a mesostructured film is a three-dimensional periodic mesostructured material having three-dimensional structural periods.

(B) Mesoporous Film Having Pores Filled with Primarily Organic Compound

Wall materials of this type of mesoporous film may be similar to those described in above (A). A substance filling the pores is not limited to particular one on condition that the substance primarily contains an organic compound. Here, the term “primarily” implies that the content is 50% or more by volume ratio. That organic compound may be made of, e.g., a surfactant, a material in which a portion having the function of forming a molecular aggregate forms a wall region, or a material in which such a portion is bonded to a precursor of a material forming a wall region. The surfactant may be, e.g., one of the examples of the surfactant, which have been mentioned in above (A). The material in which a portion having the function of forming a molecular aggregate forms a wall region, or the material in which such a portion is bonded to a precursor of a material forming a wall region may be, e.g., alkoxysilane having an alkyl group, or a oligosiloxane compound having an alkyl group. The chain length of an alkyl chain therein is to be 10 or more and 22 or less in terms of carbon number.

Water, an organic solvent, salt, etc. may be optionally contained within the pores depending on cases or depending or materials and/or operations used. Examples of the organic solvent include alcohol, ether, and hydrocarbons.

The mesoporous film having pores filled with primarily an organic compound may be fabricated through similar operations to those in the method of forming the mesoporous film, described in above (A), except for removing the mold molecules.

As in above (A), when a mesostructured film has a structure in which plural pores filled with the organic compound are elongated in a uniaxial direction and those pores are two-dimensionally periodically arrayed in a plane perpendicular to the uniaxial direction, that mesostructured film is a two-dimensional periodic mesostructured material having two-dimensional structural periods. Also, when a mesostructured film has a structure in which pores filled with the organic compound are cavities having mesoscale diameters and those pores are three-dimensionally periodically arrayed, that mesostructured film is a three-dimensional periodic mesostructured material having three-dimensional structural periods.

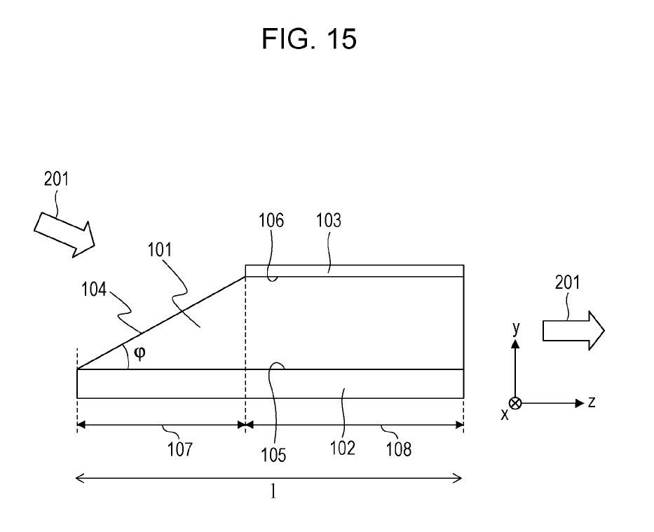

With reference to FIG. 15, an X-ray waveguide system according to the present disclosure will be described below. The x-ray waveguide system according to the present disclosure includes at least an X-ray source and an X-ray waveguide. The X-ray source emits, as an X-ray, electromagnetic waves in a general X-ray band at wavelengths of 1 pm or longer and 100 nm or shorter. The X-ray emitted from the X-ray source may have a single wavelength or a certain width of wavelength. The X-ray emitted from the X-ray source is incident upon an end of the X-ray waveguide. The waveguide of the X-ray waveguide system according to the present disclosure includes a core and a cladding. The core has a periodic structure in which plural substances having different refractive-index real parts are periodically arrayed in a direction perpendicular to an X-ray guiding direction. Given that a maximum length of the core in the X-ray guiding direction is l, a maximum thickness of the core is t, and the Bragg angle of the periodic structure of the core for the X-ray emitted from the X-ray source is θ_{B}(°), at least one end surface of a core region in the X-ray guiding direction is inclined at an inclination angle φ(°), which satisfies the above-mentioned formula (1), with respect to an interface between the core and the cladding in a plane containing a direction that is parallel to the X-ray guiding direction and a direction that is perpendicular to the interface between the core and the cladding. Furthermore, the above description regarding the X-ray waveguide is similarly applied to the X-ray waveguide used in the X-ray waveguide system according to the present disclosure.

### Example 1

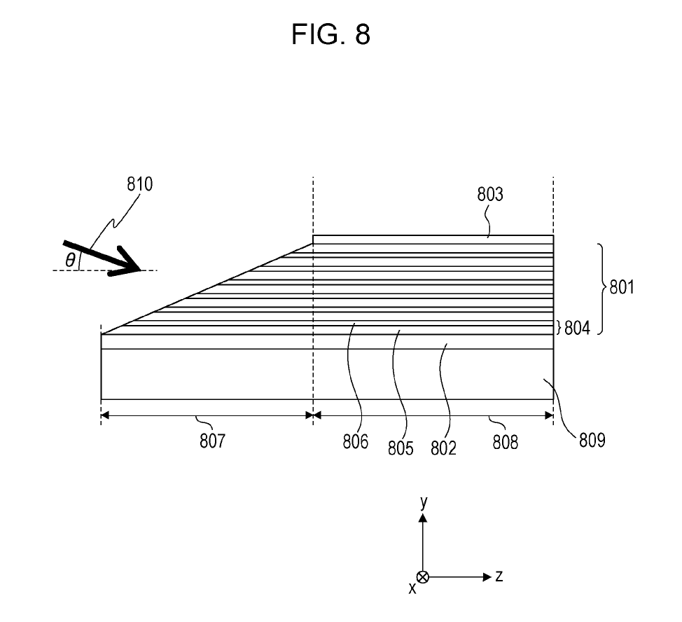

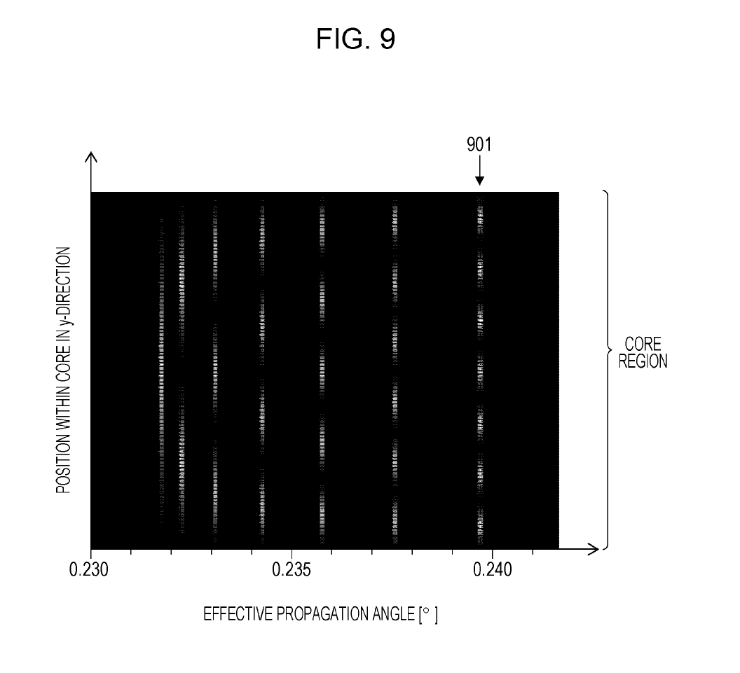

FIG. 8 illustrates an X-ray waveguide representing EXAMPLE 1 of the present disclosure. In FIG. 8, a direction toward the backside of the drawing sheet from the front side is defined as an x-axis (x-) direction, a direction toward the upper side of the drawing sheet from the lower side is defined as a y-axis (y-) direction, and a direction toward the right side of the drawing sheet from the left side, i.e., an X-ray guiding direction, is defined as a z-axis (z-) direction. In FIG. 8, the z-direction is parallel to an interface between a core 801 and a lower cladding 802. The core has a periodic structure 804. The X-ray waveguide of this EXAMPLE is fabricated by laminating plural layers on a Si substrate 809 in the y-direction with sputtering. The X-ray waveguide has a structure that the core 801 is sandwiched between a lower cladding 802 having a thickness of 20 nm and an upper cladding 803 having a thickness of 10 nm. The core 801 has a periodic structure that a carbon layer 805 having a thickness of 46 nm and a nickel layer 806 having a thickness of 2.5 nm are alternately laminated in the y-direction. Seven carbon layers are formed in the entire core 801. Such a periodic structure has the Bragg angle of about 0.18° for an X-ray with photon energy of 8 keV (kilo-electron volts). An end surface of the core 801 on the X-ray incident side is inclined at an inclination angle φ=10(°) with respect to an interface between the lower cladding 802 and the core 801. In the X-ray waveguide having the above-described shape, a core region of the waveguide in the X-ray guiding direction includes a coupling region 807 and a waveguide region 808. FIG. 9 is a graph representing an electric-field intensity distribution within the core 801 in a waveguide mode, which is created in the X-ray waveguide of EXAMPLE 1 by the X-ray with photon energy of 8 keV, with respect to a position in the y-direction and an effective propagation angle in the waveguide mode. In FIG. 9, a whiter portion implies that the intensity of an electric field is higher. Looking at a coupled mode having an electric-field intensity distribution, denoted by 901, which is obtained with coupling through evanescent waves between single-layer waveguides where individual carbon layers serve as respective cores, the effective propagation angle of the coupled mode is about 0.24(°). Therefore, the X-ray is made incident upon the core at the incident angle θ˜0.24(°) with respect to the z-direction. A direction of the incident X-ray is denoted by 810 (FIG. 8). The incident X-ray is gradually coupled to the core 801 in the coupling region 807, starting from the side close to the lower cladding 802, and is smoothly coupled to the waveguide mode in the waveguide region 808. In an X-ray incident portion of the X-ray waveguide of EXAMPLE 1, the size s′ of the region of the X-ray directly entering the end surface of the waveguide core, which has the inclined end surface, is about 1.02 s with respect to the size s of the region of the X-ray directly entering the end surface of the waveguide core, which does not have the inclined end surface.

### Example 2

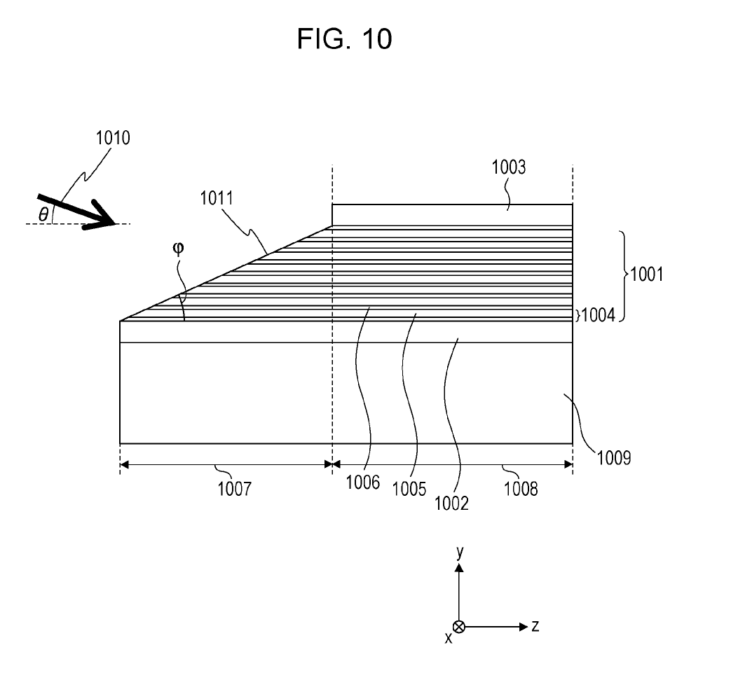

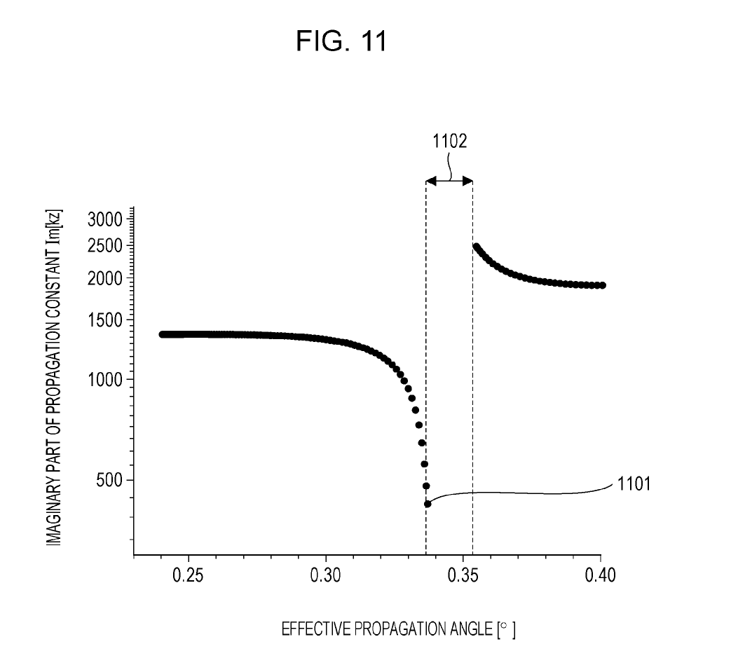

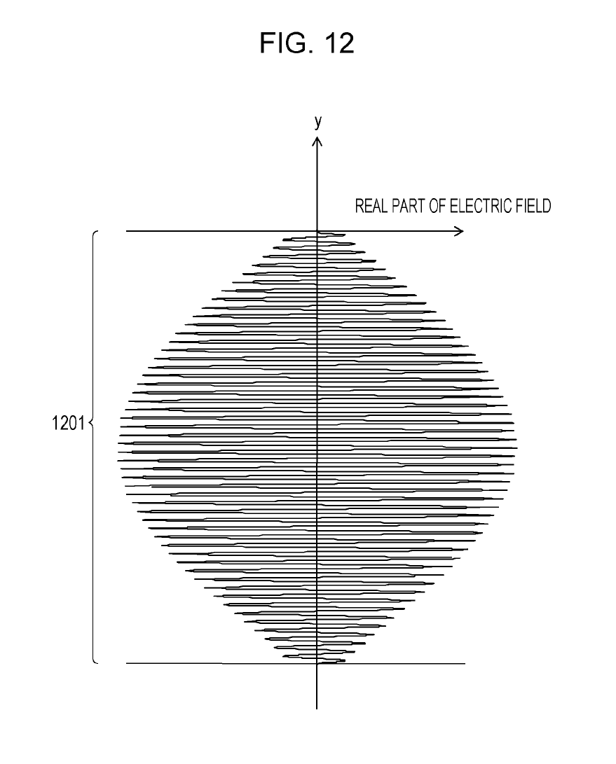

FIG. 10 illustrates an X-ray waveguide representing EXAMPLE 2 of the present disclosure. In FIG. 10, an x-axis (x-) direction, a y-axis (y-) direction, and a z-axis (z-) direction are defined as in FIG. 8 representing EXAMPLE 1. Further, an X-ray guiding direction in the X-ray waveguide is defined as the z-direction, i.e., a direction parallel to an interface between a core 1001 and a lower cladding 1002. In the X-ray waveguide of EXAMPLE 2, the core 1001 is formed on a Si substrate 1009 in a state sandwiched between the lower cladding 1002 made of tungsten (W) and having a thickness of 20 nm and an upper cladding 1003 made of tungsten (W) and having a thickness of 20 nm. The core 1001 has a periodic structure in which unit structures 1004 each including an aluminum oxide (Al₂O₃) layer 1006 having a thickness of 3 nm and a boron carbide (B₄C) layer 1005 having a thickness of 12 nm are periodically laminated in the y-direction. A periodic number is 100, and a period is 15 nm. However, because layers adjacent to the lower cladding 1002 and the upper cladding 1003 are each formed as an aluminum oxide (Al₂O₃) layer, an additional one aluminum oxide (Al₂O₃) layer is laminated on the hundred laminated unit structures. FIG. 11 is a graph representing a calculation result plotting a loss of a waveguide mode created in the X-ray waveguide of EXAMPLE 2, the loss being given as an imaginary part of the propagation constant thereof, with respect to an effective propagation angle of the waveguide mode for an X-ray with photon energy of 8 keV (kilo-electron volts). In FIG. 11, reference numeral 1101 denotes a point where the loss of the periodic resonance waveguide mode is low, and the effective propagation angle at that point is about 0.34(°) that is near the Bragg angle θ_{B} corresponding to a Bragg reflection band 1102. In consideration of such a relationship, a direction of an incident X-ray, denoted by an arrow 1010 in FIG. 10, is set to have the incident angle θ of about 0.34(°), which is substantially the same as the effective propagation angle near the Bragg angle θ_{B}, with respect to the X-ray guiding direction, i.e., to the z-direction. Here, a core end surface 1011 is inclined at the inclination angle φ˜0.34(°) with respect to the interface between the core 1001 and the lower cladding 1002 in order that an X-ray in a propagation mode close to the periodic resonance waveguide mode is gradually created in an X-ray coupling region 1007. In the X-ray waveguide of EXAMPLE 2, an electric-field distribution of the X-ray propagating through the coupling region 1007 becomes close, at an interface between the coupling region 1007 and a waveguide region 1008, to an electric-field distribution of the periodic resonance waveguide mode within the core 1001, illustrated in FIG. 12. Accordingly, the X-ray propagating through the coupling region 1007 is smoothly coupled to the periodic resonance waveguide mode in the waveguide region 1008, and high coupling efficiency is obtained. In FIG. 12, a range 1201 in the y-direction corresponds to the core 1001 in the waveguide region 1008 illustrated in FIG. 10. Moreover, in an X-ray incident portion of the X-ray waveguide of EXAMPLE 2, s′ is about 2 s. Thus, a cross-sectional area of the X-ray entering the core is about twice that in the waveguide not having the inclined core end surface.

### Example 3

In an X-ray waveguide of EXAMPLE 3, tungsten (W) is further formed on the X-ray waveguide of EXAMPLE 2 in a thickness of about 2 nm by sputtering. Stated another way, the upper cladding of the X-ray waveguide illustrated in FIG. 10 has a thickness of about 22 nm, and a tungsten film in a thickness of about 2 nm is formed on the core end surface 1011. In the X-ray waveguide of EXAMPLE 3, comparing with the X-ray waveguide of EXAMPLE 2, the X-ray otherwise radiated to the outside of the core due to scattering, etc. in the coupling region 1007 is reduced through total reflection at the core end surface 1011, whereby more efficient coupling is obtained.

### Example 4

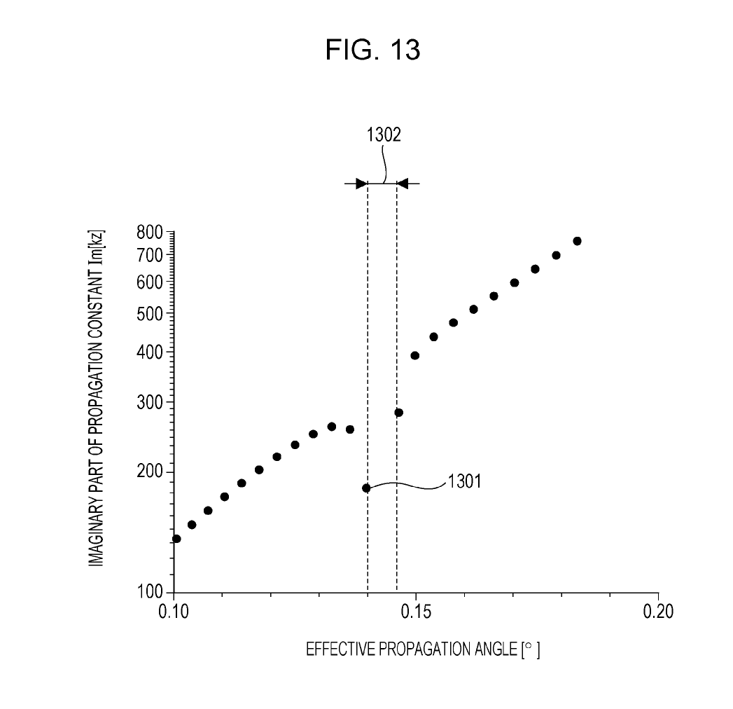

In an X-ray waveguide of EXAMPLE 4, the core 1001 of the X-ray waveguide of EXAMPLE 2 is formed of a one-dimensional periodic mesostructure. The periodic mesostructure in EXAMPLE 4 is a mesostructured film having a lamella structure in which unit structures each including a silica (SiO₂) layer having a thickness of about 3 nm and an organic layer having a thickness of about 12 nm are alternately laminated in a thickness corresponding to 25 periods. A period of the periodic structure is about 15 nm. The mesostructured film is prepared by the sol-gel method of coating a precursor solution over a Si substrate by dip coating. The precursor solution is prepared by adding a precursor, which is an inorganic oxide, to a solution of surfactant whose aggregate serves as a mold. In EXAMPLE 4, the precursor solution is prepared by using a block polymer as the surfactant, tetraethoxysilane as the inorganic oxide precursor, and ethanol as a solvent, respectively, by adding water, hydrochloric acid, and a homopolymer for hydrolysis of the inorganic oxide precursor, and by stirring a mixture. Mixing ratios (mol ratios) are tetraethoxysilane: 1, block polymer: 0.016, water: 8, hydrochloric acid: 0.01, ethanol: 40, and homo-polymer: 0.008. The block polymer is a tri-block copolymer of polyethylene glycol (106)-polypropylene glycol (70)-polyethylene glycol (106) (numeral in ( ) denotes a repetition number in each block). The homopolymer is polypropylene glycol 4000 (numeral denotes molecular weight). The prepared solution is diluted to an appropriate concentration for adjustment of a film thickness, and a film is formed at a rate of 0.5 mm/s by using a dip coating device. The mesostructured film is formed along an inner wall of a cladding through a self-organization process when the solvent of the coated solution is volatized. The formed mesostructured film provides the periodic structure that serves as a part of the core. In the mesostructure as the periodic structure, a layer of an organic substance and a layer of silica (SiO₂) are alternately laminated. FIG. 13 is a graph plotting a loss of a waveguide mode created in the X-ray waveguide of EXAMPLE 4, the loss being given as an imaginary part (Im [kz]) of the calculated propagation constant thereof, with respect to an effective propagation angle (°) of the waveguide mode. In FIG. 13, reference numeral 1301 denotes a dropped point of the loss of the periodic resonance waveguide mode (i.e., the imaginary part of the propagation constant) and the corresponding effective propagation angle. In the illustrated case, the effective propagation angle of the periodic resonance waveguide mode is about 0.14(°), which is close to the Bragg angle indicated by a Bragg reflection band 1302, for an X-ray with photon energy of, e.g., 19.5 keV. In consideration of such a relationship, the incident angle θ(°) of the incident X-ray and the inclination angle φ(°) of the core end surface are each also set to about 0.14(°). With that setting, a loss of coupling of the X-ray to the waveguide is reduced. Further, since the periodic mesostructure is made of the organic substance and the silica, each of which has a small absorption loss of the X-ray, a propagation loss of the periodic resonance waveguide mode is also reduced. Moreover, in an X-ray incident portion of the X-ray waveguide of EXAMPLE 4, s′ is about 2 s. Thus, a cross-sectional area of the X-ray entering the core is about twice that in the waveguide not having the inclined core end surface.

### Example 5

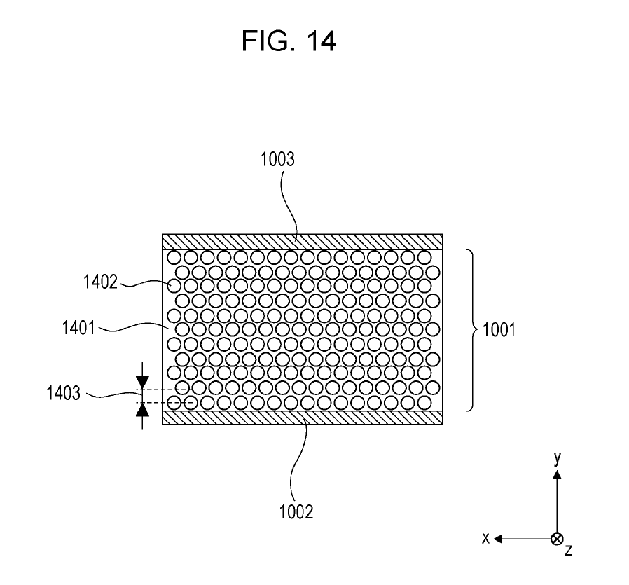

In an X-ray waveguide of EXAMPLE 5, the core 1001 of the X-ray waveguide of EXAMPLE 2 is formed of a two-dimensional periodic mesostructure. The periodic mesostructure in EXAMPLE 5 is mesoporous silica in which pores extending in the X-ray guiding direction, i.e., the z-direction, are arrayed in periodic structure having a two-dimensional triangular grid pattern in a plane perpendicular to the X-ray guiding direction. A precursor solution of the mesoporous silica in EXAMPLE 5 is prepared in a similar manner to that in EXAMPLE 4 except for setting mixing ratios (mol ratios) of the precursor solution to tetraethoxysilane: 1, block polymer: 0.006, water: 8, hydrochloric acid: 0.01, ethanol: 40, and homo-polymer: 0.003. The prepared solution is coated over a substrate, and then dried and aged. Thereafter, a mesoporous silica film is prepared by immersing the aged material in a solvent, and by removing the polymer, which has served as a mold, through extraction. FIG. 14 is a sectional view of the core 1001 and the upper and lower claddings 1003 and 1002 in the waveguide region 1008 of FIG. 10. In FIG. 14, a direction toward the left side of the drawing sheet from the right side and parallel to the interface between the core and the cladding is defined as an x-axis (x-) direction. A direction toward the upper side of the drawing sheet from the lower side and perpendicular to the interface between the core and the cladding is defined as a y-axis (y-) direction, and a direction toward the backside of the drawing sheet from the from side, i.e., the X-ray guiding direction, is defined as a z-axis (z-) direction. Pores 1402 extending through silica 1401 in the wave-guiding direction form a two-dimensional periodic structure having a triangular grid pattern in an x-y plane. A period 1403 of the periodic structure in a direction interconnecting the lower cladding 1002 and the upper cladding 1003 through the shortest distance, i.e., in the y-direction, is about 15 nm. On those conditions, the effective propagation angle of the periodic resonance waveguide mode created by an X-ray with photon energy of, e.g., 8 keV is about 0.3(°), which is close to the Bragg angle, with respect to the X-ray guiding direction. Accordingly, high coupling efficiency is obtained by setting each of the incident angle θ(°) of the incident X-ray and the inclination angle φ(°) of the core end surface to about 0.3(°). Moreover, in an X-ray incident portion of the X-ray waveguide of EXAMPLE 5, s′ is about 2 s. Thus, a cross-sectional area of the X-ray entering the core is about twice that in the waveguide not having the inclined core end surface.

The X-ray waveguide according to the present disclosure is utilized as, e.g., X-ray optical components used in X-ray optical systems for X-ray analysis techniques, X-ray imaging techniques, X-ray exposure techniques, etc.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-187166 filed Aug. 30, 2011 and No. 2011-265072 filed Dec. 2, 2011, which are hereby incorporated by reference herein in their entirety.

What is claimed is:

1. An X-ray waveguide configured to guide an X-ray to be propagated therethrough, comprising:
a core that has a periodic structure in which plural substances having different refractive-index real parts are periodically arrayed in a direction perpendicular to an X-ray guiding direction; and
a cladding disposed in contact with the core,
wherein, given that a maximum length of the core in the X-ray guiding direction is l, a maximum thickness of the core is t, and a Bragg angle of the periodic structure of the core for the X-ray is θ_{B}(°), at least one end surface of a core region in the X-ray guiding direction is inclined at an inclination angle φ(°), which satisfies a following formula (1), with respect to an interface between the core and the cladding in a plane containing a direction that is parallel to the X-ray guiding direction and a direction that is perpendicular to the interface between the core and the cladding:
tan⁻¹(t/l)<φ<90°−θ_{B} (1).

2. The X-ray waveguide according to claim 1, wherein the Bragg angle of the periodic structure of the core for the X-ray is smaller than a total-reflection critical angle at the interface between the core and the cladding and is larger than a total-reflection critical angle at an interface between the plural substances forming the periodic structure.

3. The X-ray waveguide according to claim 1, wherein the inclination angle φ(°) is equal to the Bragg angle θ_{B}(°) of the periodic structure of the core for the X-ray.

4. The X-ray waveguide according to claim 1, wherein a cladding is formed on a surface of the at least one inclined end surface of the core region in the X-ray guiding direction, and
wherein, given that a total-reflection critical angle at an interface between the cladding formed on the surface of the at least one end surface and a substance present outside the waveguide in contact with the relevant cladding is θ_{C-ext}(°), the inclination angle φ(°) and the Bragg θ_{B}(°) satisfies a following formula (6):
φ>θ_{C-ext}−θ_{B} (6).

5. The X-ray waveguide according to claim 1, wherein the core is made of a periodic multilayer film.

6. The X-ray waveguide according to claim 1, wherein the core is made of a periodic mesostructure.

7. The X-ray waveguide according to claim 1, wherein the core is made of a periodic mesoporous material.

8. An X-ray waveguide system including an X-ray source and an X-ray waveguide,
the X-ray source emitting an X-ray to enter an end of the X-ray waveguide,
the X-ray waveguide including a core and a cladding,
wherein the core has a periodic structure in which plural substances having different refractive-index real parts are periodically arrayed in a direction perpendicular to an X-ray guiding direction, and
wherein, given that a maximum length of the core in the X-ray guiding direction is l, a maximum thickness of the core is t, and a Bragg angle of the periodic structure of the core for the X-ray emitted from the X-ray source is θ_{B}(°), at least one end surface of the core in the X-ray guiding direction is inclined at an inclination angle φ(°), which satisfies a following formula (1), with respect to an interface between the core and the cladding in a plane containing a direction that is parallel to the X-ray guiding direction and a direction that is perpendicular to the interface between the core and the cladding:
tan⁻¹ (t/l)<φ<90°−θ_{B} (1).
